(19) United States
(12) Patent Application Publication
(10) Pub. No.: US 2008/0228525 A1
(43) Pub. Date: Sep. 18, 2008

(54) System for and method for providing patient education and collecting, processing, and reporting patient consumer data

(75) Inventors: Amy Weickert, Newburyport, MA (US); Paul Levine, Philadelphia, PA (US); Stanley Wulf, Berkeley, MA (US); Chip Sheerin, Rowley, MA (US)

Correspondence Address: WILMERHALE/DC, 1875 PENNSYLVANIA AVE., NW, WASHINGTON, DC, 20004, US

(73) Assignee: InfoMedics, Inc., Woburn, MA (US)

(21) Appl. No.: 11/808,188

(22) Filed: Jun. 7, 2007

Related U.S. Application Data
(60) Provisional application No. 60/907,026, filed on Mar. 16, 2007.

(51) Int. Cl. G06F 19/00

(52) U.S. Cl. 705/3

(57) ABSTRACT

The present invention is a system for and method of providing patient education, and collecting, processing, and reporting patient consumer data. The invention generates reports from information collected from patients, a medical educator, a prescribing physician, and a pharmaceutical manufacturer. A method of collecting, processing, and providing medical data and education includes developing patient survey, collecting patient data, processing patient data, and generating reports to physicians, and pharmaceutical manufacturers that validate the effectiveness of a medical treatment prescribed by the physician.

### RELATED APPLICATIONS

This application claims the benefit under 35 U.S.C. §119(e) of U.S. Provisional Patent Application No. 60/907,026, filed on Mar. 16, 2007, entitled “SYSTEM FOR AND METHOD OF PROVIDING PATIENT EDUCATION AND COLLECTING, PROCESSING, AND REPORTING PATIENT CONSUMER DATA”, which is hereby incorporated by reference herein in its entirety.

### FIELD OF THE INVENTION

The present invention relates to a system and method for patient education to support disease awareness, treatment and compliance with specified prescription medication use. In particular, this invention relates to a system for and method of collecting and reporting patient data, anticipating individuals' projected compliance levels and responding with relevant education for medical patients, and then reporting individual patient medical survey response data and confirmation of education provided to the patients to prescribing physicians, as well as reporting aggregate, de-identified patient data to pharmaceutical manufacturers.

### BACKGROUND OF THE INVENTION

Programs, protocols, and information tools for educating patients about their medical condition and the drugs used to treat these conditions are common in today's medical industry. For example, physicians, pharmaceutical manufacturers, and patient advocacy groups routinely provide websites, brochures, videos, and other media that attempt to better inform patients regarding best practices for identifying and managing various medical conditions, using medications, and adhering to treatments provided by prescribing physicians.

However, these traditional sources of patient information are not typically tailored to specific patient groups. As a result, patients seeking information on medical conditions and treatments are forced to sift through a great deal of information that may not be relevant to their specific condition, demographic makeup, or medical history. Patients seeking to become better educated about their condition or treatment may quickly become overwhelmed with the amount of generalized information available and, as a result, make uninformed choices regarding their medical care, or fail to adhere to the prescribed treatment. In addition, physicians are often then burdened with having to assist the patient in sorting through the relevant information pertaining to their particular health condition or potentially fending off inappropriate medications or diagnoses. The problem of treatment non-adherence is particularly pervasive with patients suffering asymptomatic disorders such as high cholesterol and hypertension, due to the fact that prescribed treatments may appear to have little or no impact on these conditions. This situation can discourage patients from complying with their prescribed treatment, and therefore become dissatisfied with their physician and/or the prescribed medication.

Prescribing physicians often lack a robust feedback mechanism that allows them to understand how specific patients are complying with and responding to prescribed medication treatments. Typically, physicians schedule follow-up appointments for some period following prescription of medications to their patients. However, in many cases, it would benefit the physician to learn about patient treatment adherence and response prior to the scheduled follow-up treatment, particularly in cases where the patient has a high likelihood of non-adherence to a prescribed treatment. This knowledge would allow the physician to understand the patient's status and intervene more quickly and provide a higher quality of care.

To maximize sales and better provide products and services, pharmaceutical manufacturers depend on reliable data from physicians and patients regarding satisfaction with specific medications, levels of treatment adherence, and demographic information relating to specific patient groups of interest. However, in many cases, there is often inadequate information provided by physicians and patients for pharmaceutical manufacturers to refine their products and sales strategies. A robust, reliable, and timely means of obtaining information from patients and physicians would allow pharmaceutical manufacturers to provide higher quality products and services to its customers, refine its production and marketing strategies, and maximize sales of its products and services.

What is needed is a system and method for close and efficient communication between patients, physicians, and pharmaceutical manufacturers regarding the treatment of medical conditions. More specifically, what is needed is a way to collect patient medical data, educate patients regarding treatments of their medical condition(s), and report individualized medical treatment data to prescribing physicians and aggregate that data to report it to pharmaceutical manufacturers in an efficient and timely manner. Ready and timely access to customized treatment education for patients can lead to a higher degree of patient compliance, satisfaction with the prescribing physician and treatment, a greater likelihood of patient treatment adherence, and a higher degree of quality health outcomes.

It is an object of the invention to project an individual's likely compliance level with a prescribed medication through targeted baseline survey responses.

It is therefore an object of the invention to then provide tailored educational information to patients regarding their medical condition and treatment in order to encourage their compliance.

It is another object of this invention to provide a way for prescribing physicians to better understand how well their patients comprehend their conditions and prescribed treatments.

It is yet another object of this invention to provide a way for prescribing physicians to better understand how their patients respond to prescribed treatments.

It is yet another object of this invention to provide pharmaceutical manufacturers with information relating to patient understanding and usage patterns of the products and services produced by the pharmaceutical manufacturers.

It is yet another object of this invention to provide pharmaceutical manufacturers with a third-party channel to convey confirmation of individualized patient education, comprehension and medication response feedback to physicians.

It is yet another object of this invention to provide a means of sharing treatment and consumer data between medical education providers, patients, physicians, and pharmaceutical manufacturers in an efficient and timely manner.

### SUMMARY OF THE INVENTION

Embodiments of the invention include a system and method for providing patient education and reporting of patient data for a plurality of patients. The system and method provide, to each patient of the plurality of patients, tailored medical education and tailored treatment information relating to a medical condition of the patient. This is done by sending a survey to each patient and receiving, from each patient, a survey response. A compliance factor is then calculated for each patient, based on the patient's survey response. The survey responses and calculated compliance factors are then reported to a treating physician for each patient. The reports have patient specific information. Reports to the manufacturer of the medications include aggregated patient information from the survey responses. These reports also include aggregated compliance factors.

In other embodiments of the invention patient education and sending and receiving of survey data is done through the Internet using a web-based interface. In still other embodiments, additional surveys are used to collect more information from patients. In still other embodiments, receiving of survey responses, along with processing and reporting to physicians and pharmaceutical manufactures is done at about the same time, in order to efficiently and quickly update interested parties.

### BRIEF DESCRIPTION OF THE DRAWINGS

FIG. 1 is a functional block diagram of a system for collecting, processing, and providing medical data and education in accordance with the present invention.

FIG. 2 is a flow diagram of a method of collecting, processing, and providing medical data and education in accordance with the invention.

FIG. 3 is a physician report having patient specific information, including completed education and compliance information

### DESCRIPTION OF THE INVENTION

The present invention is a system for and method of collecting and reporting patient medical data and providing patient education.

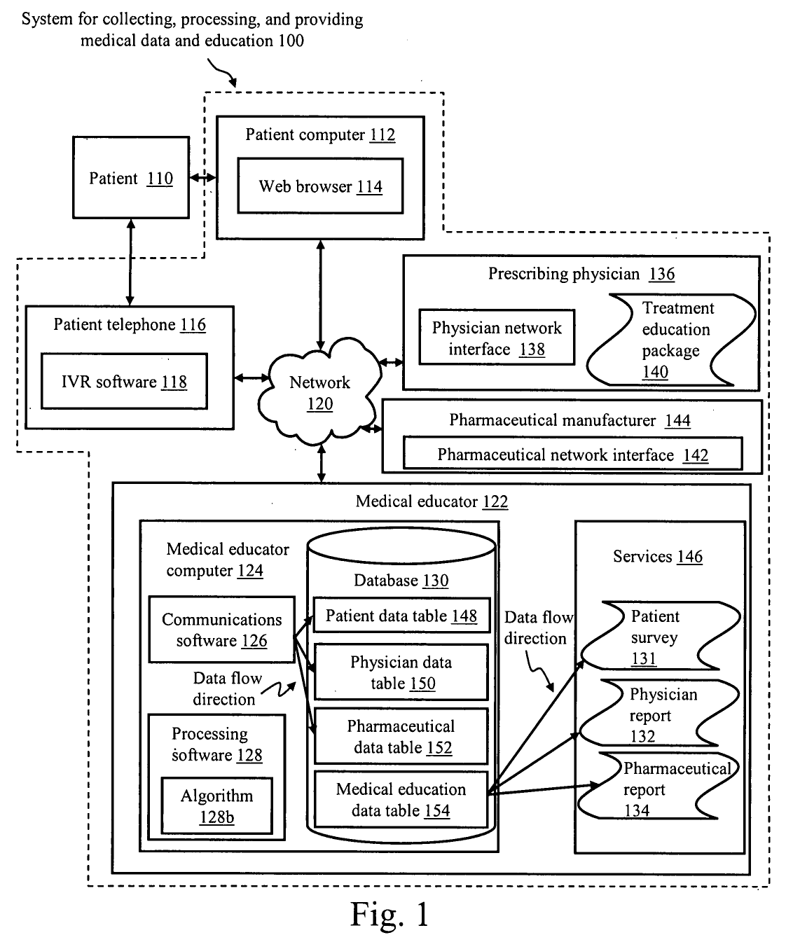

A system for collecting, processing, and providing medical data and education 100 in accordance with the invention is shown in FIG. 1. The System 100 includes a patient computer 112, a patient telephone or wireless device 116, a patient wireless device, a network 120, and a medical educator computer 124 on which medical educator operates.

Patient computer 112 further includes a web browser 114. Patient telephone 116 is a standard telephone for communicating with Interactive Voice Response (IVR) software 118 that resides on a server at the Medical Educator. Patient telephone 116 can be either wireless or land-line.

Patient 110 is a person receiving medical treatment from prescribing physician 136 for a specific medical condition. Patient 110 uses conventional communication channels, such as patient telephone 116, in-person meetings (not shown), U.S. Postal methods, or electronic communications, via a patient computer 112, wireless devices, faxing, email, etc., through network 120, to provide data for discussions, facilitating the establishment of relationships with the prescribing physician 136.

Patient computer 112 is any standard networked or wireless computer used to access the Internet and includes web browser 114, which is a software program that provides a graphical interface that lets users click buttons, icons, and menu options to view and navigate Web pages.

Treatment education package 140 comprises a collection of printed and/or electronic material relating to (1) the prescription and use of specific medications produced by a pharmaceutical manufacturer 144, and (2) details relating to the enrollment of prescribing physician 136 and patient 110 into a medical education program provided by medical educator 122.

Prescribing physician 136 will require access to a physician network interface 138 and treatment education package 140. Physician network interface 138 allows a prescribing physician 136 to receive and transmit information via network 120. Examples of physician network interface 138 include any standard networked computer used to access the Internet, a telephone system, or method for receiving printed material, such as the U.S. Postal Service.

Pharmaceutical manufacturer 144 must have access to pharmaceutical network interface 142. Pharmaceutical network interface 142 allows a pharmaceutical manufacturer 144 to receive and transmit information via network 120. Examples of a pharmaceutical network interface 142 include any standard networked computer server used to access the Internet, a telephone system, or method for receiving printed material such as the U.S. Postal Service.

In the preferred embodiment, network 120 is an electronic communications network, such as a local-area network (LAN), a wide-area network (WAN), an intranet or the Internet. However, it will be understood by those skilled in the art that network 120 may be a telephone network, conventional mail system, or other network through which information is carried.

The Medical Educator 122 will provide a number of services 146. Services 146 are a collection of reporting functions that include: (1) medical education provided to patient 110 relating to his/her condition; (2) data reported to prescribing physician 136 relating to patient 110 treatment compliance and other quality of care factors; and (3) aggregated data reported to pharmaceutical manufacturer 144 relating to sales and marketing of specific medications produced by pharmaceutical manufacturer 144.

Services 146 further include the providing of a patient survey 131, physician reports 132, and pharmaceutical reports 134. Patient survey 131 is, for example, an electronic survey containing questions targeted to patient 110 designed to collect demographic information from patient 110 and assess his/her understanding of his/her treatment and condition. Patient survey 131 questions may, for example, relate to patient 110 demographic information, conditions and treatments related to his/her medical condition, baseline level of patient 110 education regarding his/her condition, likelihood that patient 110 will be adherent to the treatment prescribed by prescribing physician 136, and level of patient 110 satisfaction with the prescribed medication. Patient survey 131 questions may be developed by, for example, a combination of input from publicly available articles and surveys, pharmaceutical manufacturer 144 sales and research staff, medical educator 122 brand teams, and prescribing physician 136. An example portion of patient survey 131 with questions relating to treatment compliance history and numerical scores provided by an example patient 110 is provided in Table 1.

TABLE 1
Example Patient Survey 131 (Medication Compliance Predictor portion)

| Patient Question | Patient Score |
|---|---|
| How often do you forget to take your medicines? | 6 |
| Choose any number on a scale from 0 to 10, with 0 meaning you never | |
| forget to take your medicines and 10 meaning you always forget. | |
| Are you careless at times about taking medicines? | 8 |
| Choose any number from 0 to 10, with 0 meaning you are never careless | |
| and 10 meaning you are always careless. | |
| When you feel better, how often do you stop taking your medicines? | 9 |
| Choose any number from 0 to 10, with 0 meaning you never stop and 10 | |
| meaning you always stop. | |
| If you feel worse, how often do you stop taking your medicines? | 4 |
| Choose any number from 0 to 10, with 0 meaning you never stop and 10 | |
| meaning you always stop. | |

Patient survey 131 also contains condition and treatment educational information targeted at the specific demographic profile and condition of patient 110. In this way, patient 110 is provided with both generalized and tailored information that will assist him/her in better managing his/her condition.

Medical educator 122 utilizes a medical educator computer 124, which is any standard networked computer server that is a system for hosting a website. Medical educator computer 124 further includes communications software 126, processing software 128, and a database 130.

Communications software 126 contains a Web server that provides World Wide Web services, such as a website, and may include multiple servers. In the preferred embodiment, communications software 126 provides a website that allows patient 110 to submit and receive information related to their medical condition, and treatment history. Communications software 126 may also contain IVR software capable of receiving and transmitting between medical educator computer 124 and patient telephone 116.

Database 130 is a standard database system, such as those widely available from Oracle, Microsoft, or IBM, that contains a comprehensive collection of related data, for example, patient demographics, patient medical history, and levels of patient treatment education. Database 130 further includes a patient data table 148, a physician data table 150, a pharmaceutical data table 152 and a medical education data table 154.

Table 2, below, illustrates exemplary data stored in patient data table 148 of database 130. Data in patient data table 148 is derived from patient survey 131 and is evaluated, subsequently, by processing software 128. A specific example of how processing software 128 evaluates patient data table 148 is described below with reference to processing software 128.

TABLE 2
Example Patient Data Table 148

| Patient Name | Patient1 |
|---|---|
| Date of Birth | May 25, 1942 |
| Sex | M |
| Height | 72 inches |
| Weight | 173 lbs. |
| Forgets Recommended Medications - Patient Score | 6 |
| Careless About Medications - Patient Score | 8 |
| Stops Medications When Feels Better - Patient Score | 9 |
| Stops Medications If Feels Worse - Patient Score | 4 |

Table 3, below, illustrates exemplary data stored in physician data table 150, which is stored in database 130, and which is evaluated, subsequently, by processing software 128. A specific example of how processing software 128 evaluates physician data table 150 is described below with reference to processing software 128.

TABLE 3
Example Physician Data Table 150

| | |
|---|---|
| Patient Name | Patient1 |
| Date of Birth | May 25, 1942 |
| Diagnosis | High Cholesterol |
| Prescribed Medication | CureAll |
| Dosage | 145 mg/day |
| Provided Medication Information? | Yes |
| Reconfirmed MI on 1^{st} follow-up? | Yes |
| Provided Understanding Cholesterol | Yes |
| Information? | |
| Reconfirmed UC on 1^{st} Follow-up? | Yes |
| Provided Cholesterol & Triglycerides | Yes |
| Information? | |
| Reconfirmed CT on 1^{st} Follow-up? | Yes |
| Provided Heart Disease Information? | Yes |
| Reconfirmed HD on 1^{st} Follow-up? | Yes |
| Provided Benefits of Exercise Information? | Yes |
| Reconfirmed BE on 2^{nd} Follow-up? | Yes |
| Provided Exercise Goals Information? | Yes |
| Reconfirmed EG on 2^{nd} Follow-up? | Yes |
| Provided Healthy Diet Information? | Yes |
| Reconfirmed HD on 2^{nd} Follow-up? | Yes |
| Provided Lowering Cholesterol Intake | Yes |
| Information? | |
| Reconfirmed LC on 2^{nd} Follow-up? | Yes |

Table 4, below, illustrates exemplary data stored in pharmaceutical data table 152, which is stored in database 130, and which is evaluated, subsequently, by processing software 128. A specific example of how processing software 128 evaluates pharmaceutical data table 152 is described below with reference to processing software 128.

TABLE 4
Example Pharmaceutical Data Table 152

| | |
|---|---|
| Medication Name | Cure All |
| Indications | High cholesterol |
| Possible Side Effect1 | Nausea |
| Possible Side Effect2 | Dizziness |
| Usage Alert1 | Only with food |
| Usage Alert2 | Not with alcohol |

Table 5, below, illustrates exemplary data stored in medical education data table 154, which is stored in database 130, and portions of which are reported, subsequently, in patient survey 131, physician report 132, and pharmaceutical report 134. A specific example of how processing software 128 evaluates medical education data table 154 is described below with reference to processing software 128.

TABLE 5
Example Medical Education Data Table 154

| | |
|---|---|
| Patient Name | Patient1 |
| Date of Birth | May 25, 1942 |
| Program Information | |
| Baseline Medication | Med1 |
| Baseline Medication Usage Frequency | NA |
| 1^{st} Follow-up Medication | CureAll |
| 1^{st} Follow-up Usage Frequency | Daily |
| 2^{nd} Follow-up Medication | CureAll |
| 2^{nd} Follow-up Usage Frequency | Daily |
| Educational Support | |
| Provided Medication Information? | Yes |
| Reconfirmed MI on 1^{st} follow-up? | Yes |
| Provided Understanding Cholesterol Information? | Yes |
| Reconfirmed UC on 1^{st} Follow-up? | Yes |
| Provided Cholesterol & Triglycerides Information? | Yes |
| Reconfirmed CT on 1^{st} Follow-up? | Yes |
| Provided Heart Disease Information? | Yes |
| Reconfirmed HD on 1^{st} Follow-up? | Yes |
| Provided Benefits of Exercise Information? | Yes |
| Reconfirmed BE on 2^{nd} Follow-up? | Yes |
| Provided Exercise Goals Information? | Yes |
| Reconfirmed EG on 2^{nd} Follow-up? | Yes |
| Provided Healthy Diet Information? | Yes |
| Reconfirmed HD on 2^{nd} Follow-up? | Yes |
| Provided Lowering Cholesterol Intake Information? | Yes |
| Reconfirmed LC on 2^{nd} Follow-up? | Yes |
| Medications Adherence Predictor | |
| Forgets Recommended Medications - Patient Score | 6 |
| Careless About Medications - Patient Score | 8 |
| Stops Medications When Feels Better - Patient Score | 9 |
| Stops Medications If Feels Worse - Patient Score | 4 |
| Calculated Risk of Non-Compliance | High |
| Lifestyle Behaviors | |
| Baseline LB Diet | Pre-contemplation |
| Baseline LB Exercise | Contemplation |
| 1^{st} Follow-up LB Diet | Preparation |
| 1^{st} Follow-up LB Exercise | Action |
| 2^{nd} Follow-up LB Diet | Action |
| 2^{nd} Follow-up LB Exercise | Action |
| Medication Satisfaction | |
| 1^{st} Follow-up MS - Patient Score | 7 |
| 2^{nd} Follow-up MS - Patient Score | 8 |
| Intent to Continue Medication | Maybe |
| Recommend Medication to Others | Maybe |

Processing software 128 is a software program that includes a pre-programmed algorithm 128b. Pre-programmed algorithm 128b calculates patient treatment compliance data and other quality-of-care factors based on data stored in patient data table 148, physician data table 150, and pharmaceutical data table 152. For example, patient 110 may indicate in patient survey 131 a date of birth, gender, height, weight, and a various scores in response to questions relating to his/her history of non-compliance with treatment regimens prescribed in the past as shown in Table 2. In reference to Table 2, example patient 110 has input numerical scores of 6, 8, 9, and 4 to the questions relating to compliance history in patient survey 131, as shown in Table 1. Based on these values, algorithm 128b calculates a moderate to high risk of treatment non-compliance (as shown in Table 5) for patient 110 using the following algorithm:

Sum of the 4 Medication Adherence Predictor ratings, each scored from 0 to 10 (Total: 0 minimum to 40 maximum):

Score: 0-10: Low Risk of Non-Compliance
11-15: Low to Moderate Risk of Non-Compliance
16-25: Moderate Risk of Non-Compliance
26-30: Moderate to High Risk of Non-Compliance
31-40: High Risk of Non-Compliance

Compliance scores provided by patient 110 and the calculated non-compliance risk score are stored in medical education data table 154 and are reported (in various portions and formats) in patient survey 131, physician report 132, and pharmaceutical report 134.

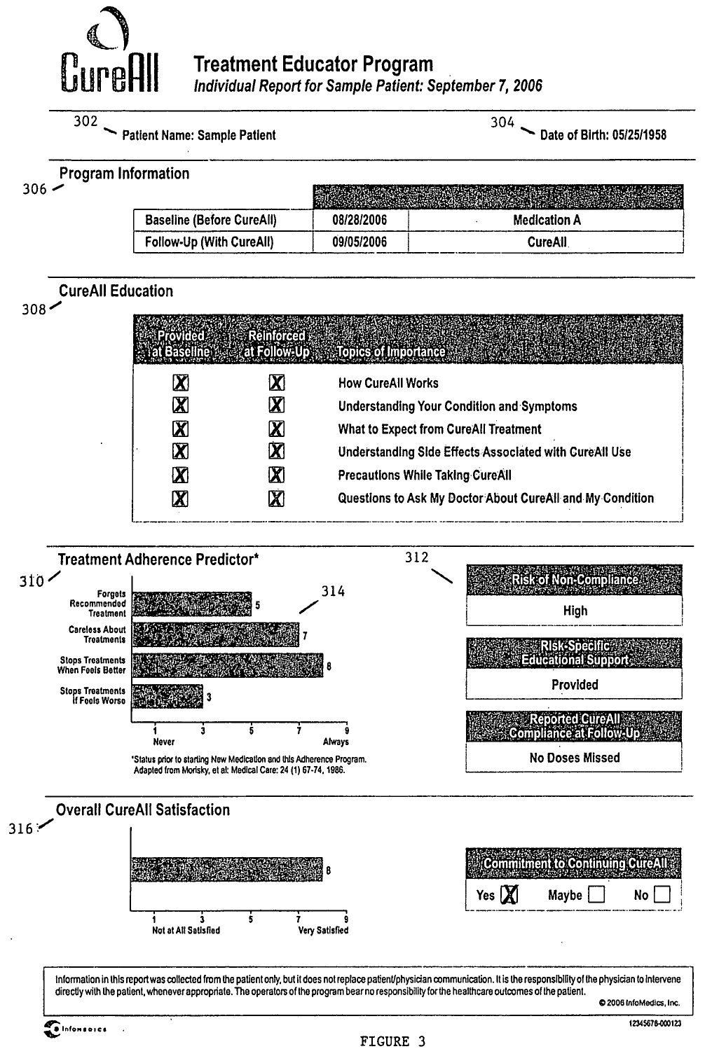

An example of physician report 132 is shown in FIG. 3. FIG. 3 illustrates a physician report having patient specific information, including education and compliance information. Patient specific demographic information such as name 302 and date of birth 304 are shown at the top, and serve to identify the patient. Program information 306 tells the physician the medications the patient has been prescribed. Below program information 306 is a summary of the education 308 that the patient has received and the education that has been followed up on. Below summary of education 308 is compliance information 310 that is based on this patient's survey response.

A calculated compliance factor 312 is also displayed. This compliance factor can be qualitative (as shown), numeric, or any other representation that describes the patient's compliance with the prescribed treatment program. The survey response data 314 is shown in the left of this section. Physician report 132 also has a report on the patient's overall satisfaction 316 with the prescribed treatment. This report, based on such things as the patient's survey responses and information from a pharmaceutical manufacturer, is only one example of a report that may be supplied to a physician. The physician report 132 can also contain more or less information if desired.

It will be understood by those skilled in the art that a multitude of preprogrammed algorithms 128b may be utilized by processing software 128; this example does not limit the types of preprogrammed formulas that processing software 128 may use.

Physician report 132 is generated by processing software 128 based upon data stored in database 130. Physician report 132 contains information specific to an individual patient 110 such as name, date of birth, medication prescribed, baseline level of patient 110 education regarding his/her condition and treatment, a quantitative indicator of the likelihood that patient 110 will be adherent to the treatment prescribed by prescribing physician 136, and level of patient 110 satisfaction with the prescribed medication.

Pharmaceutical report 134 is generated by processing software 128 based upon data stored in database 130. Pharmaceutical report 134 contains aggregated medical data for multiple numbers of patients, such as patient satisfaction levels with a specific medication, patient compliance history with a specific medication, patient knowledge levels of the side effects of a specific medication, physician prescription-writing trends for specific medications, medication brand performance, and treatment education program summaries.

Prescribing physician 120 treats patient 110 by assessing patient condition, providing medical guidance, and prescribing medications. Physician network interface 138 serves as a means of communication between network 120 and prescribing physician 136. Physician network interface 138 may be for example, a standard networked computer server used to access the Internet, a telephone, a wireless device, or a system for receiving printed material, such as the U.S. Postal Service.

Pharmaceutical manufacturer 144 produces and markets medications for treating medical conditions. Pharmaceutical network interface 142 serves as a means of communication between network 120 and pharmaceutical manufacturer 144. Pharmaceutical network interface 142 may be, for example, a standard networked computer server used to access the Internet, a telephone, or a system for receiving printed material, such as the U.S. Postal Service.

In operation, upon securing a fee-for-service contract with pharmaceutical manufacturer 144, medical educator 122 collects data and information from pharmaceutical manufacturer 144 relating to its products and services (e.g., medication names, possible side effects, usage alerts, and acceptable dosages). Medical educator 122 stores these data in pharmaceutical data table 152 of database 130. Additionally, a sales team from pharmaceutical manufacturer 144 enrolls prescribing physician 136 at no cost into the medical education program offered by medical educator 122. In exchange for enrollment, prescribing physician 136 receives detailed reports from medical educator 122 relating to the effectiveness of medications he/she is prescribing to participating patients, as described by those patients.

Patient 110 seeks treatment from prescribing physician 136 for a medical condition via an in-person visit. Prescribing physician 136 prescribes an appropriate medication to treat patient 110, instructs patient 110 in the medication's use, and provides patient 110 with treatment education package 140. Patient 110 reads information in treatment education package 140 and enrolls in medical education program via patient computer 112 or patient telephone or other patient input channel (fax/wireless device/BCR) 116. Following program enrollment, patient 110 accesses the medical educator computer 124 via network 120 and communications software 126. Patient 110 receives educational information relating to his/her condition and treatment and responds to patient survey 131 provided by medical educator computer 124. Patient 110 responses are interpreted by algorithms contained in processing software 128 and stored in patient data table 148 of database 130. For example, patient 110 might respond to patient survey 131 questions with demographic information (e.g., age, weight, height, sex) and respond to a series of questions relating to his/her treatment compliance history.

Based on the data stored in patient data tables 148, physician data tables 150, and pharmaceutical data tables 152, processing software 128 calculates a patient score based on the likelihood that he/she will be compliant with prescribed treatment. Processing software 128 stores the results of these calculations in medical education data tables 154 of database 130. As described above, medical educator 122 provides a collection of reporting services 146. For example, processing software 128 generates physician report 132 that is transmitted to prescribing physician 136 via network 120 and physician network interface 138. Prescribing physician 136 may use the information contained in patient physician report 132 to modify or complement the prescribed treatment. Processing software 128 generates aggregated pharmaceutical report 134 that is transmitted to pharmaceutical manufacturer 144 via network 120 and pharmaceutical network interface 142. Pharmaceutical manufacturer 144 may use the information contained in aggregated pharmaceutical report 134 to improve production and marketing of the medications it produces.

Patient survey 131, physician report 132, and pharmaceutical report 134 are transferred in real-time, or close to real-time, between patient 110, medical educator 122, prescribing physician 136, and pharmaceutical manufacturer 144. This efficient and timely transfer of information improves the level of treatment provided by prescribing physician 136 and the quality of products provided by pharmaceutical manufacturer 144, thus improving the overall quality of healthcare received by patient 110.

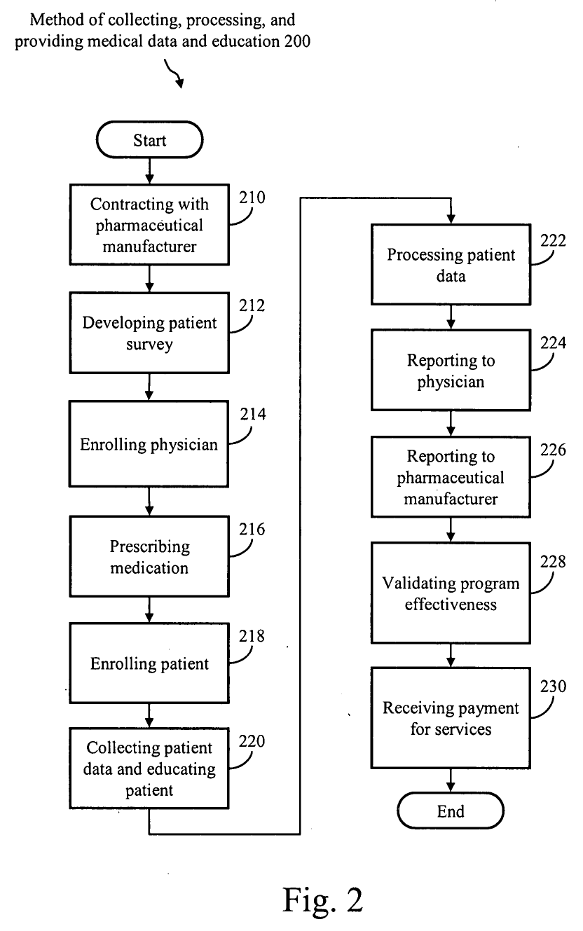

Referring to FIG. 2 the method of collecting, processing, and providing medical data and education will now be described.

In step 210, medical educator 122 establishes a fee-for-service contract with pharmaceutical manufacturer 144 to provide services 146. Services 146 include pharmaceutical reports 134, which provides aggregated patient and physician consumer information for patients being prescribed medication(s) produced by pharmaceutical manufacturer 144. Also in this step, 210 pharmaceutical manufacturer 144 provides information relating to its products and services (e.g., medication names, possible side effects, usage alerts, and acceptable dosages). Medical educator 122 stores this data in pharmaceutical data table 152 of database 130.

In step 212, pharmaceutical manufacturer 144 and clinical staff and brand team from the medical educator 122 develop patient survey 131 that provides questions for patient 110 relating to conditions and treatments regarding medications produced by pharmaceutical manufacturer 144. Patient survey 131 questions may come from, for example, published articles, pharmaceutical manufacturer 144 sales and research staff, and prescribing physician 136.

In step 214, sales staff from pharmaceutical manufacturer 144 enrolls prescribing physician 136 into the treatment education program. During enrollment, prescribing physician 136 receives treatment education package 140 from pharmaceutical manufacturer 144 sales staff. Treatment education package 140 contains, for example, enrollment information for prescribing physician 136 to provide to patient 110, treatment educational material, and a patient confidentiality statement. Prescribing physician 136 receives detailed reports from medical educator 122 relating to the effectiveness of medications he/she is prescribing to participating patients.

In step 216, prescribing physician 136 prescribes a medication to patient 110 in the normal context of a patient examination, diagnosis and treatment regimen. Then in step 218, the prescribing physician 136 invites patient 110 to participate in a treatment education program related to his/her medical condition and treatment. Upon agreement from patient 110, prescribing physician 136 provides patient 110 with the patient-specific portion of education package 140. Patient 110 may then enroll by contacting medical educator 122 via patient computer 112, patient telephone 116, or a business reply card (not shown), for example.

In step 220, patient 110 completes the patient survey 131 described above in connection with step 212 and receives educational material related to his/her medical condition and treatment and according to his/her specific demographic profile, illness, and condition. In this way, patient 110 is provided with both generalized and tailored information that will assist him/her in better managing his/her condition. Patient survey 131 may be completed via patient computer 112 or patient telephone 116, for example. Educational material is also delivered to patient 110 via patient computer 112, U.S. Mail, or patient telephone 116, for example. Patient responses to patient survey 131 are transmitted to the medical educator computer 124 via network 120 and communications software 126. Data from patient survey 131 are stored in patient data table 148 of database 130. Also in this step, processing software 128 populates medical education data table 154 with data relating to the condition, medication, and dosage of patient 110 based on data stored in patient data table 148, physician data table 150, and pharmaceutical data table 152. Data stored in medical education data table 154 is reported to patient 110 in survey 131 as education material that can assist patient 110 in more effectively managing his/her condition.

Patient 110 may be requested by physician 136 or medical educator 122 to take additional patient survey(s) 131 periodically so as to gauge changes in patient levels of understanding of regarding his/her condition and treatment.

In step 222, processing software 128 processes the data stored in patient data table 148, physician data table 150, and pharmaceutical data table 152 of database 130. The particular processes are designed by clinical staff of medical educator 122 to determine various factors that may impact the treatment prescribed in step 216, such as the knowledge of patient 110 regarding his/her condition and the likelihood that patient 110 will be adherent to the treatment prescribed in step 216.

In step 224, database 130 generates physician report 132 and transmits this report to the prescribing physician via network 120 and physician network interface 138. Physician report 132 contains information specific to patient 110 such as name, date of birth, level of patient education regarding his/her condition and treatment, and a quantitative indicator of the likelihood that patient 110 will be adherent to the treatment prescribed in step 216.

In step 226, the medical education computer generates pharmaceutical report 134 and transmits report 134 to pharmaceutical manufacturer 144 via network 120 and pharmaceutical network interface 142. Pharmaceutical report 134 contains aggregated medical data for multiple numbers of patients participating in the medical educator program, such as patient satisfaction levels with a specific medication, patient compliance history with a specific medication, patient knowledge levels of the side effects of a specific medication, and prescription writing trends for a specific medication.

In step 228, medical educator 122 contracts with a third-party pharmaceutical sales data aggregator to validate the effectiveness of the treatment education program in increasing sales of the brand(s) of medication of interest to pharmaceutical manufacturer 144. One example of third-party pharmaceutical sales data aggregator is IMS Health Inc. The third-party data aggregator performs statistical analysis on prescription writing data sets across similar physician groups and compares results to those physicians enrolled in the treatment education program provided by medical educator 122. The third-party data aggregator produces a report that medical educator 122 utilizes to demonstrate the effectiveness of the treatment education program to pharmaceutical manufacturer 144.

In step 230, assuming satisfactory performance, medical educator 122 submits an invoice to pharmaceutical manufacturer 144 based on the terms of the contract established in step 210 for services 146 provided. Pharmaceutical manufacturer 144 remits payment to medical educator 122.

The process described above addresses the objectives of this invention in many ways. It educates patient 110 about his/her medical condition and treatment in a timely and efficient manner. The process also provides timely information to prescribing physician 136 about the likelihood that patient 110 will be treatment adherent and whether patient 110 is satisfied with a prescribed medication, thus making the service provided by prescribing physician 136 more effective in improving the quality of health care provided by prescribing physician 136. Finally, the process also provides pharmaceutical manufacturer 144 with timely critical sales information related to its products so that it can improve its products and services, maximize sales, and improve the quality of health care it provides.

What is claimed is:

1. A method for providing patient education and reporting of patient data for a plurality of patients comprising:
(a) providing, to each patient of the plurality of patients, tailored medical education and tailored treatment information relating to a medical condition of the patient;
(b) sending a survey to each patient;
(c) receiving, from each patient, a survey response;
(d) calculating a compliance factor for each patient, based on the patient's survey response;
(e) reporting, to a treating physician for each patient, patient specific information from the survey response of the patient, including at least the compliance factor of the patient; and
(f) reporting, to a manufacturer of a medication, wherein the medication is prescribed to one or more of the patients from the plurality of patients, aggregated patient information from the survey responses of the one or more patients to whom the medication is prescribed, including at least aggregated compliance factors.

2. The method of claim 1, wherein the survey response includes information on a patient's understanding of said provided tailored medical education.

3. The method of claim 1, wherein the survey response includes information on a patient's response to a prescribed treatment.

4. The method of claim 1, wherein said survey and said survey response are transmitted through at least one of the Internet, an interactive voice response system, and postal mail.

5. The method of claim 1, wherein said survey and survey response are processed through a web based interface.

6. The method of claim 1, further comprising the steps of:
(g) sending a second survey to each patient;
(h) receiving, from each patient, a second survey response;
(i) reporting, to a treating physician for each patient, patient specific information from the second survey response of the patient, including at least the compliance factor of the patient; and
(j) reporting, to a manufacturer of a medication, wherein the medication is prescribed to one or more of the patients from the plurality of patients, aggregated patient information from the second survey responses of the one or more patients the medication is prescribed to, including at least aggregated compliance factors.

7. The method of claim 1, wherein the aggregated patient information includes information on at least one of, patient satisfaction levels with the medication prescribed, patient compliance history with the medication prescribed, patient knowledge regarding side effects of the medication prescribed, and prescription writing trends of the medication prescribed.

8. The method of claim 1, wherein the tailored medical education and tailored treatment information relating to a medical condition of the patient is provided via multiple communication channels.

9. A system for providing patient education and reporting of patient data for a plurality of patients comprising:
a computer with a database storing patient data, physician data, and pharmaceutical data, wherein the computer is connected, through a network, to a plurality of patient computers for providing tailored medical education and tailored treatment information relating to a medical condition; and
wherein the database also stores survey responses from the plurality of patients, the survey responses being used to generate a physician report with patient specific information and a compliance factor, and being used to generate a pharmaceutical report with aggregated patient information and aggregated compliance factors.

10. The system of claim 9, wherein the physician report and the pharmaceutical report include information on a patient's understanding of the provided tailored medical education.

11. The system of claim 9, wherein the physician report and the pharmaceutical report include information on a patient's response to a prescribed treatment.

12. The system of claim 9, wherein the network is at least one of the Internet, an interactive voice response system, and postal mail.

13. The system of claim 9, wherein the computer further comprises a web server for a web based interface to the plurality of connected patient computers.

14. The system of claim 9, wherein at least two of the survey responses from the plurality of survey responses stored in the database, are from the same patient.

15. The system of claim 9, wherein the aggregated patient information includes information on at least one of, patient satisfaction levels with a prescribed medication, patient compliance history for a prescribed medication, patient knowledge regarding side effects of a prescribed medication, and prescription writing trends of a prescribed medication.

16. The system of claim 9, wherein the computer and the plurality of patient computers are connected via multiple communication channels.
